(19) United States
(12) Patent Application Publication
(10) Pub. No.: US 2017/0004361 A1
(43) Pub. Date: Jan. 5, 2017

(54) METHOD FOR DETECTING DISCREPANCIES IN A PART DRAWING

(71) Applicant: Caterpillar Inc., Peoria, IL (US)

(72) Inventors: Jeffrey Paul Sayre, Glen Ellyn, IL (US); Derek James Quam, Metamora, IL (US)

(73) Assignee: Caterpillar Inc., Peoria, IL (US)

(21) Appl. No.: 14/788,826

(22) Filed: Jul. 1, 2015

(51) Int. Cl. G06K 9/00; G06K 9/62; G06K 9/34

(52) U.S. Cl. CPC G06K 9/00476; G06K 9/344; G06K 9/00456; G06K 9/00449; G06K 9/6202; G06K 9/6212

(57) ABSTRACT

A method pursuant to embodiments of the present disclosure includes performing an Optical Character Recognition process on a part drawing and creating a character set. The method further includes identifying part call-out information from a plurality of part call-outs on the part drawing and from the character set; identifying bill of material information from a bill of materials (BOM) on the part drawing and from the character set; and comparing the part call-out information with the bill of material information.

### TECHNICAL FIELD

The present disclosure relates to a method for detecting discrepancies, and more particularly, to a method for detecting accuracies and discrepancies in a part drawing using an Optical Character Recognition (OCR) process.

### BACKGROUND

In recent times, part drawings used by engineering firms have become detailed, complex, and/or bulky in nature owing to a large number and type of parts being used in an assembly. In such cases, several part call-outs may be typically required for providing information pertaining to the various parts of the part drawing. Moreover, a large bill of materials may also be present alongside such part drawings for listing a type and number of each part present in the part drawing.

In creating a part drawing, one may sometimes inadvertently misquote a class of a part i.e., a type of part used in one or more part call-outs of the part drawing or in its associated bill of materials. In some cases, the class disclosed in one or more part call-outs may be incorrect and hence, such class may not even exist in the bill of materials associated with the part drawing. In other cases, a total quantity obtained from various part call-outs for a given class of a part in the part drawing may be more or less than that disclosed in the associated bill of materials. In still other cases, large number of parts belonging to the same class may be inadvertently disclosed as being used at a single location on the part drawing. In these cases, a person who subsequently uses the part drawing may be led to believe that a cluster of such parts exist at that single location in the part drawing.

These and other types of inadvertent errors can raise doubts with respect to the accuracy of the information disclosed in the part call-outs of the part drawing. Moreover, as such type of errors can cause incorrect or inaccurate part drawings to be produced; the errors can have a tendency to negatively impact subsequent manufacturing and/or assembly processes in which the part drawing is used.

Hence, there is a need for a method and/or a system that is configured to detect discrepancies between information that is disclosed in part call-outs of a part drawing and information that is listed in a bill of materials associated with the part drawing.

### SUMMARY OF THE DISCLOSURE

In one aspect of the present disclosure, a method pursuant to embodiments of the present disclosure includes performing an Optical Character Recognition (OCR) process on a part drawing and creating a character set. The method further includes identifying part call-out information from a plurality of part call-outs on the part drawing and from the character set; identifying bill of material information from a bill of materials (BOM) on the part drawing and from the character set; and comparing the part call-out information with the bill of material information.

In another aspect of the present disclosure, the step of comparing the part call-out information with the bill of material information includes determining a class of an item on the part drawing from the part call-out information, and identifying if the class of the item from the part call-out information is present in the bill of materials information. Further, the step of comparing includes determining a first quantity value for the class from the part call-out information, and a second quantity value for the class from the bill of material information; and identifying whether the first quantity value and second quantity value for the class are equal. Furthermore, the step of comparing includes identifying whether the first quantity value for a given class disclosed in a part call-out exceeds a standard deviation for the first quantity value measured from all the part call-outs present in the part drawing, each of the part call-outs being associated with the given class.

In yet another aspect of the present disclosure, the method includes providing a first indication if the class from the part call-out information is present in the bill of materials information, and if the first quantity value and second quantity value for the class are equal. The method further includes providing a second indication if the class from the part call-out information is not present in the bill of materials information. The method further includes providing a third indication if the first quantity value and second quantity value for the class are not equal. The method further includes providing a fourth indication if the first quantity value for the given class disclosed in the part call-out exceeds the standard deviation measured for the first quantity value from all the part call-outs for the given class in the part drawing.

Other features and aspects of this disclosure will be apparent from the following description and the accompanying drawings.

### BRIEF DESCRIPTION OF THE DRAWINGS

FIG. 1 is a plan view of an exemplary part drawing, in which embodiments of the present disclosure can be implemented;

FIG. 2 is a low-level implementation of a method in accordance with an embodiment of the present disclosure that can be implemented on the exemplary part drawing of FIG. 1 to detect accuracies and discrepancies in the information disclosed in one or more part call-outs on the part drawing with information that is listed in an associated bill of materials;

FIG. 3 is an exemplary character set obtained by performing an Optical Character Recognition (OCR) Process on the exemplary part drawing of FIG. 1;

FIGS. 4-7 are plan views of the exemplary part drawing from FIG. 1, in which various types of accuracies and discrepancies have been detected using the method of FIG. 2;

FIG. 8 is a high-level method flow chart, pursuant to embodiments of the present disclosure, that can be implemented on the exemplary part drawing of FIG. 1 to detect accuracies and discrepancies between information that is disclosed in one or more part call-outs on the part drawing and information that is listed in an associated bill of materials; and

FIG. 9 is a block diagram of an exemplary computer system that can be configured to execute instructions consistent with embodiments of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

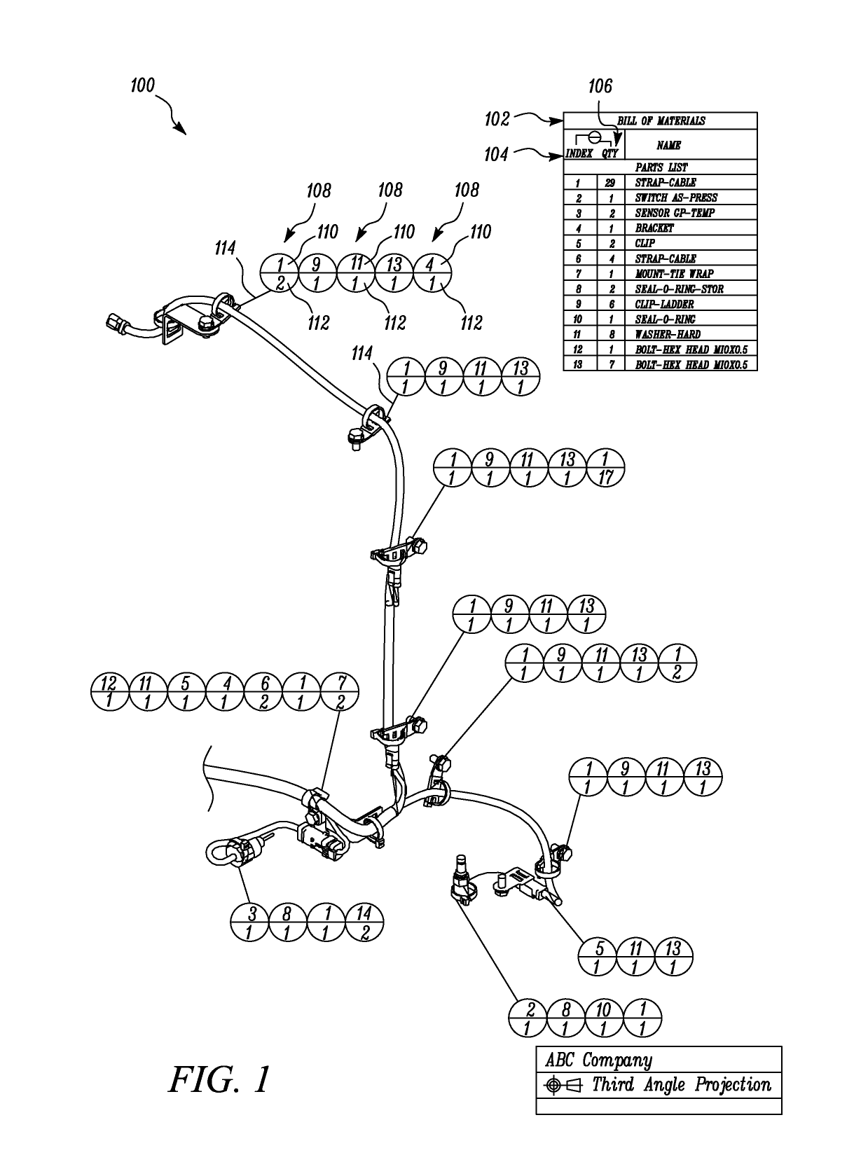

FIG. 1 shows a plan view of an exemplary part drawing 100, in which embodiments of the present disclosure can be implemented. As shown, the part drawing 100 of FIG. 1 shows a conduit assembly in which a conduit is being assembled and routed from one location to another using various types of components (hereinafter referred to as ‘parts’ or ‘items’). Although the part drawing 100 is illustrated in the form of the conduit assembly, any type of part drawing could be used in lieu of the part drawing 100 i.e., the conduit assembly to implement embodiments of the present disclosure.

Particulars such as a type and quantity of each part used in forming the part drawing 100, in this case—the conduit assembly, are listed in an associated bill of materials (BOM) 102. As shown, the BOM 102 is located alongside the part drawing 100 and is presented in a tabular form to include an ‘index’, and a ‘quantity’ under distinct columns with headers denoted by numerals ‘104’ and ‘106’ respectively (shown in FIG. 1).

For the purposes of this disclosure, the index 104 can be regarded as being representative of several unique ‘classes of items’, wherein each class of item denotes a unique type of item that should ideally be present in the part drawing 100. In the illustrated embodiment of FIG. 1, the classes are serially numbered in the index 104 from one through thirteen (1-13). The term ‘quantity’ (listed under header ‘106’) represents a quantity of items in each class that should ideally be present in the part drawing 100. For example, class—11 denotes ‘Hard-washers’ and quantity value—8 denotes that there should be eight pieces or numbers of ‘Hard-washers’ present in the part drawing 100.

The part drawing 100 further includes several part call-outs 108. These part call-outs 108 provide information pertaining to a class and quantity of various parts/items used in the part drawing 100. In the illustrated embodiment of FIG. 1, an upper half 110 i.e., numerator of each part call-out 108 denotes a class of the part while a lower half 112 i.e., denominator of each part call-out 108 indicates the quantity value of the part/item used at that location of the part drawing 100.

The part drawing 100 further includes one or more leader lines 114 that are configured to link each of the part call-outs 108 with part/s or items shown on the part drawing 100. When several classes of parts/items are present at a single location on the part drawing 100 so as to form a cluster or a sub-assembly of parts/items, the respective part call-outs 108 for the various classes of parts in the cluster or sub-assembly may be spaced away from the part drawing and sequentially arranged in a single row. Moreover, such cluster or sub-assembly of parts may be linked to the part call-outs 108 using a single leader line 114. For example, at a top portion of the part drawing from FIG. 1, a cluster or sub-assembly of parts is formed by using parts having classes 1, 9, 11, 13, and 4, and the multiple part call-outs 108 used to disclose such unique classes i.e., 1, 9, 11, 13, and 4 may be arranged in a single row and linked to the parts on the part drawing 100 by a single leader line 114.

As disclosed earlier herein, the information disclosed in each part call-out 108 includes a class and quantity for the given class of parts at a location on the part drawing 100, while information disclosed in the bill of materials 102 gives the various classes and a total quantity of parts in a given class that should ‘ideally’ be present on the part drawing 100. For purposes of the present disclosure, the terms ‘first quantity value’ can be regarded as the quantity for a given class of part/item from the part call-out/s 108 and the terms ‘second quantity value’ can be regarded as the quantity disclosed for the same class of parts in the bill of materials 102.

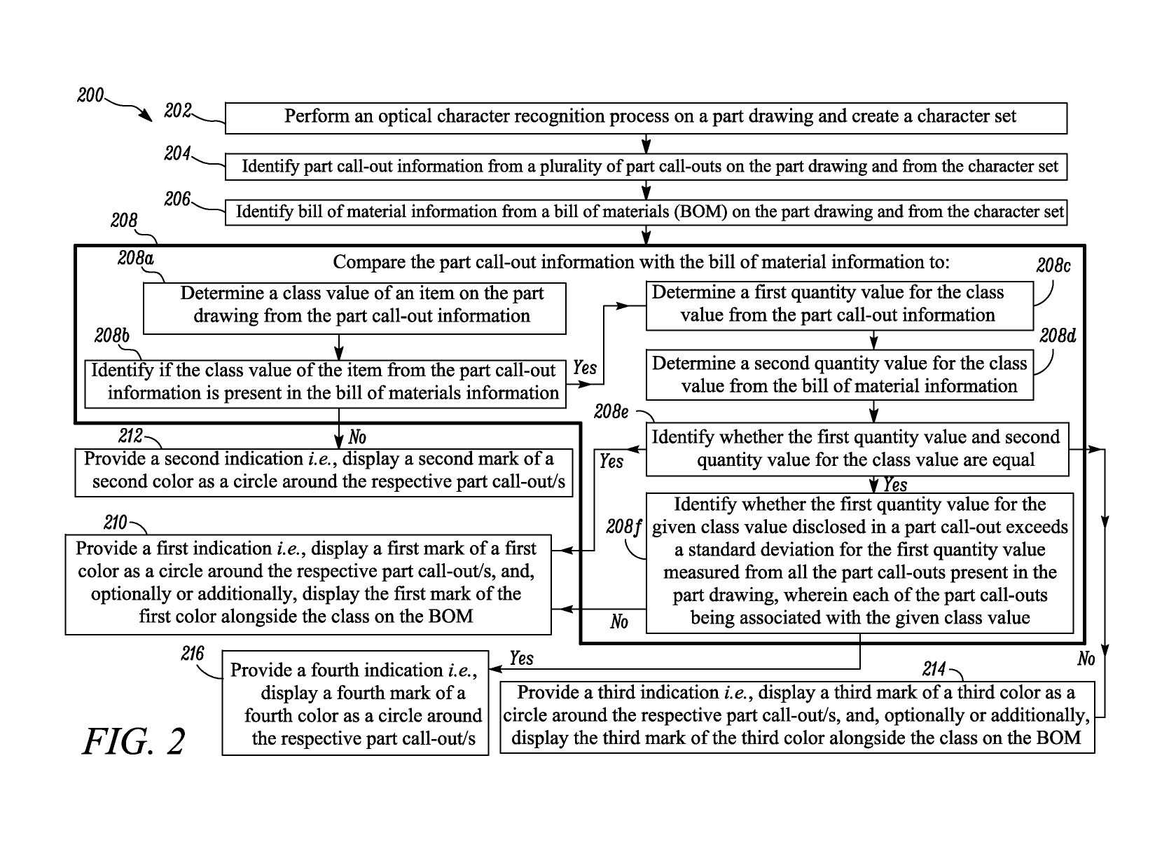

The present disclosure relates to a method 200 (shown in FIG. 2) for detecting accuracies as well as discrepancies in the information disclosed in one or more part call-outs 108 on the part drawing 100 with respect to information that is listed in the associated bill of materials 102. It will be appreciated by persons skilled in the art although the method 200 disclosed herein is beneficially configured to detect and acknowledge accuracies and discrepancies in the information from each of the part call-outs 108 with the information listed in the bill of materials 102, the method 200 could optionally be configured and implemented for detection of discrepancies alone. Therefore, it should be noted that the following disclosure should be taken in an explanatory sense and should not, in any manner, be construed as being limiting of the claims appended herein.

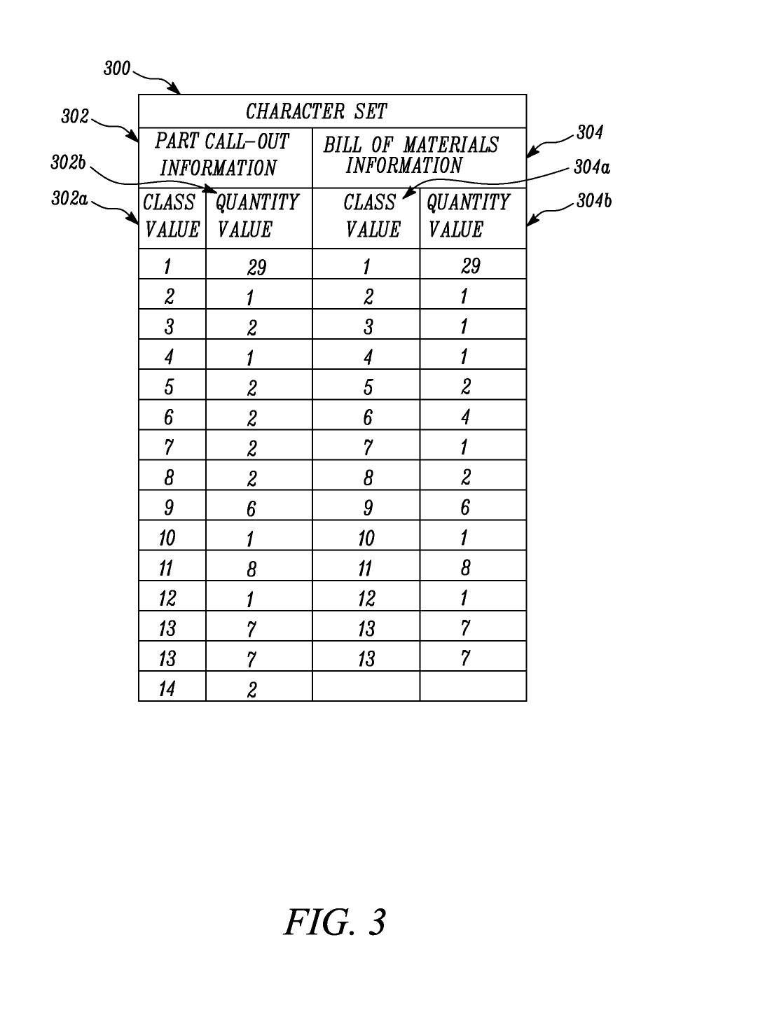

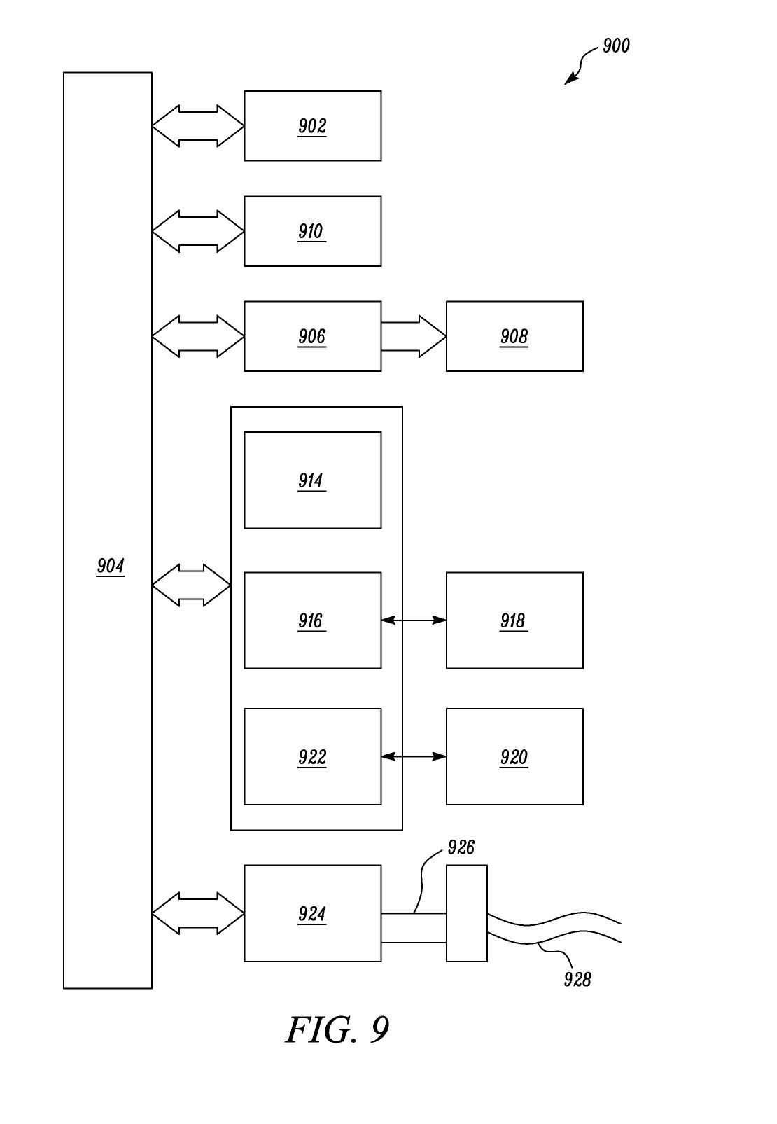

Referring to FIG. 2, at step 202, the method 200 includes performing an Optical Character Recognition (OCR) process on the part drawing 100 and creating a character set 300 (as shown in FIG. 3). As commonly known to one skilled in the art, OCR is a process that can be used to execute electronic conversion of text and images from a typewritten, printed, or digital form into machine-encoded text. The character set 300 disclosed herein includes the electronically converted machine-encoded text that is comprised of the information from various part call-outs 108 and information that is listed in the bill of materials 102, both being associated with the same part drawing 100. The creation of the character set 300 by the OCR process, disclosed in step 202, can be conveniently carried out by configuring and using any known type of general purpose machine or computer, for e.g., the computer 900 as shown in FIG. 9, with suitable commands and instructions for executing the OCR process. Moreover, the computer 900 disclosed herein may employ various algorithms (for e.g., Hough's transform), routines, and other protocols, that are typically known for executing an OCR process. Explanation pertaining to the general purpose machine or computer will be made in conjunction with FIG. 9 later in this document.

Referring again to FIGS. 2 and 3, at step 204, the method 200 further includes identifying part call-out information 302 from the plurality of part call-outs 108 on the part drawing 100 and from the character set 300 (shown in FIG. 3). Further, at step 206, the method 200 further includes identifying bill of material information 304 from the bill of materials 102 on the part drawing 100 and from the character set 300. Furthermore, at step 208, the method 200 includes comparing the part call-out information 302 with the bill of material information 304 (See FIG. 3).

In an embodiment as shown in FIG. 2, the step 208 of comparing the part call-out information 302 with the bill of material information 304 includes determining a class 302a of an item/part on the part drawing 100 (as shown in FIG. 1) from the part call-out information 302 (as shown in FIG. 3), and identifying if the class 302a of the item/part from the part call-out information 302 is present in the bill of materials information 304 (See steps 208a-208b of method 200 from FIG. 2). If the class 302a of the item from the part call-out information 302 is present in the bill of materials information 304, then the method 200 proceeds to step 208c for further determining a first quantity value 302b for the class 302a from the part call-out information 302 (See FIG. 3). The method 200 then proceeds to step 208d for determining a second quantity value 304b for the given class 302a from the bill of material information 304 (See FIG. 3). Thereafter, the method 200 proceeds to step 208e for identifying whether the first quantity value 302b and second quantity value 304b for the class 302a are equal.

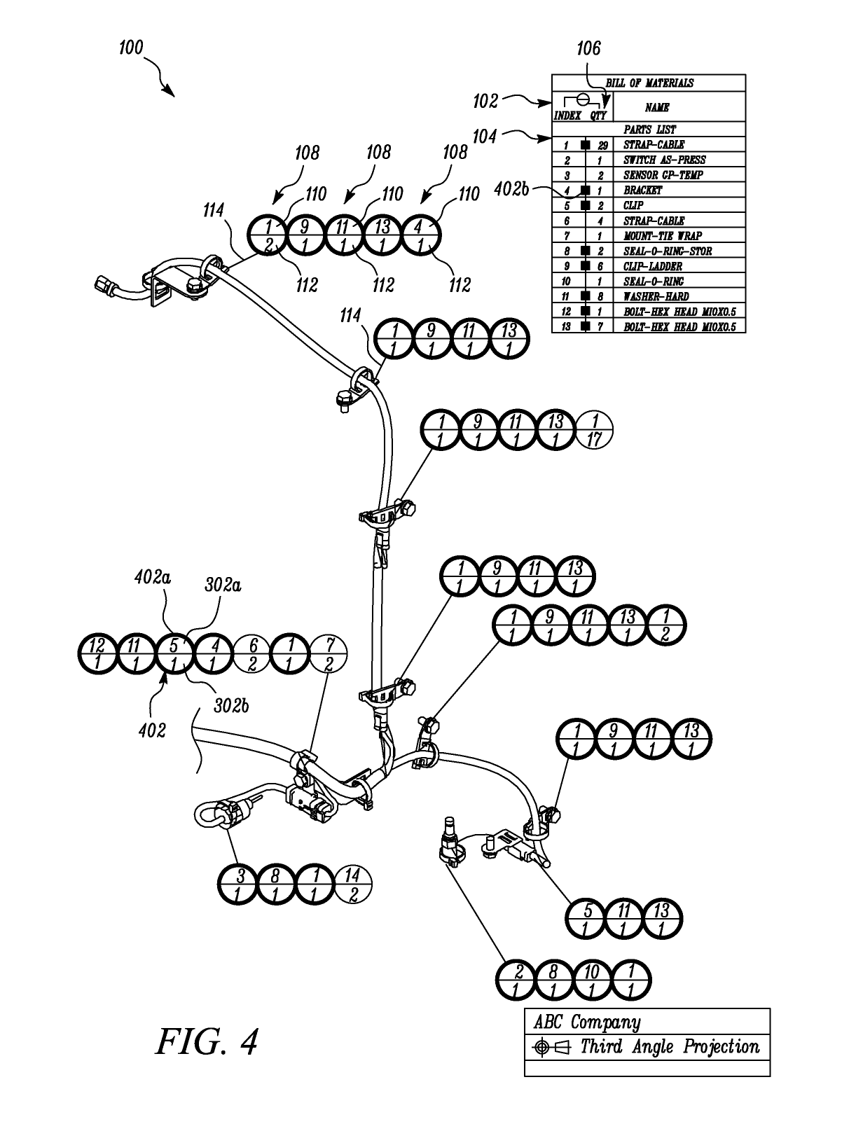

If the class 302a of the item/part from the part call-out information 302 is present in the bill of materials information 304 and if the first quantity value 302b and second quantity value 304b for the given class 302a are equal, then the method 200 proceeds to step 210 for providing a first indication 402 i.e., by displaying a first mark of a first color. The first color, disclosed herein may be for e.g., green. As shown in FIG. 4, the first mark of the first is displayed as circles color 402a around respective part call-outs 108 in which the class 302a of the item/part i.e., from the part call-out information 302 is present in the bill of materials information 304, and in which the first quantity value 302b is equal to the second quantity value 304b for the given class 302a, the second quantity value 304b also being listed in the bill of materials 102.

Moreover, if the class 302a of the item/part i.e., from the part call-out information 302 is present in the bill of materials information 304, and in which the first quantity value 302b is equal to the second quantity value 304b for the given class 302a listed from the bill of materials information 304, then the method 200 may further include displaying the first mark of the first color proximate the bill of materials 102 (See 402b in FIG. 4). As shown in FIG. 4, the first mark of the first color 402b is displayed proximate the bill of materials 102 i.e., alongside the respective classes of items in the bill of materials 102. In the exemplary part drawing 100 of FIG. 1, part call-outs 108 representing items on the part drawing 100 from classes 1, 4, 5, 8, 9, 11, 12, and 13 have been deemed to present accurate information with respect to the bill of materials 102 and are hence, shown highlighted in FIG. 4 with circles 402a of the first color for e.g., green color.

Furthermore, with continued reference to FIG. 4, the first mark 402b of the first color is also provided alongside the classes 1, 4, 5, 8, 9, 11, 12, and 13 listed in the bill of materials 102 as the part call-outs 108 for items/parts of these classes i.e., 1, 4, 5, 8, 9, 11, 12, and 13 disclose correct information 302 i.e., by way of the class 302a and the first quantity values 302b for the given class 302a against the class 304a and the second quantity value 304b listed in the bill of materials information 304 respectively. Therefore, with execution of the method 200 disclosed herein, part call-outs 108 that disclose accurate information 302 i.e., with respect to the associated bill of materials 102 is highlighted to denote that the representation of information 302 in the part call-outs 108 is correct and accurate.

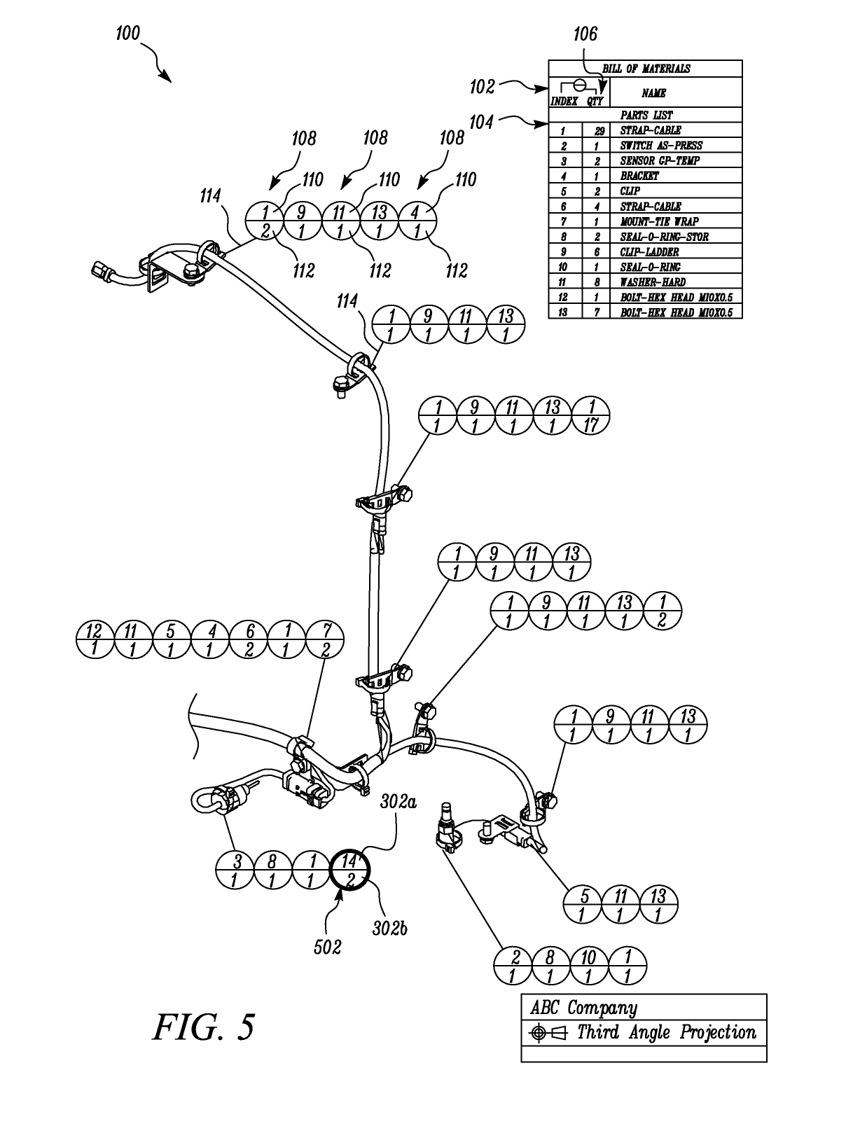

If the class 302a of the item/part from the part call-out information 302 is not present in the bill of materials information 304, then the method 200 proceeds from step 208b to step 212 for providing a second indication 502 (See FIG. 5) i.e., by displaying a second mark of a second color that is visually distinct from the first color. The second color may be for e.g., red.

As shown in FIG. 5, the second mark is displayed as circles 502 around respective part call-outs 108 in which the class 302a of the item/part i.e., from the part call-out information 302 is not present in the bill of materials information 304. In the exemplary part drawing of FIG. 1, part call-outs that disclose class—14 are deemed inaccurate as class—14 (taken from 302a of FIG. 3) does not exist in the bill of materials information 304 (taken from the BOM 102 of FIG. 3). Hence, the part call-out 108 disclosing class—14 in the part drawing 100 are shown highlighted in FIG. 5 with circles 502 of the second color for e.g., red color.

However, if the class 302a of the item/part from the part call-out information 302 is present in the bill of materials information 304, but the first quantity value 302b obtained from the part call-out information 302 is not equal to the second quantity value 304b obtained from the bill of materials information 304 for the given class 302a/304a (For example, see part call-outs disclosing classes 6 and 7 in FIG. 1 and their respective first and second quantity values 302b, 304b in FIGS. 1 and 3), then the method 200 of FIG. 2 proceeds from step 208e to step 214 for providing a third indication 602a on the respective part call-out i.e., by displaying a third mark of a third color that is visually distinct from each of the first color and the second color. The third color may be for e.g., blue.

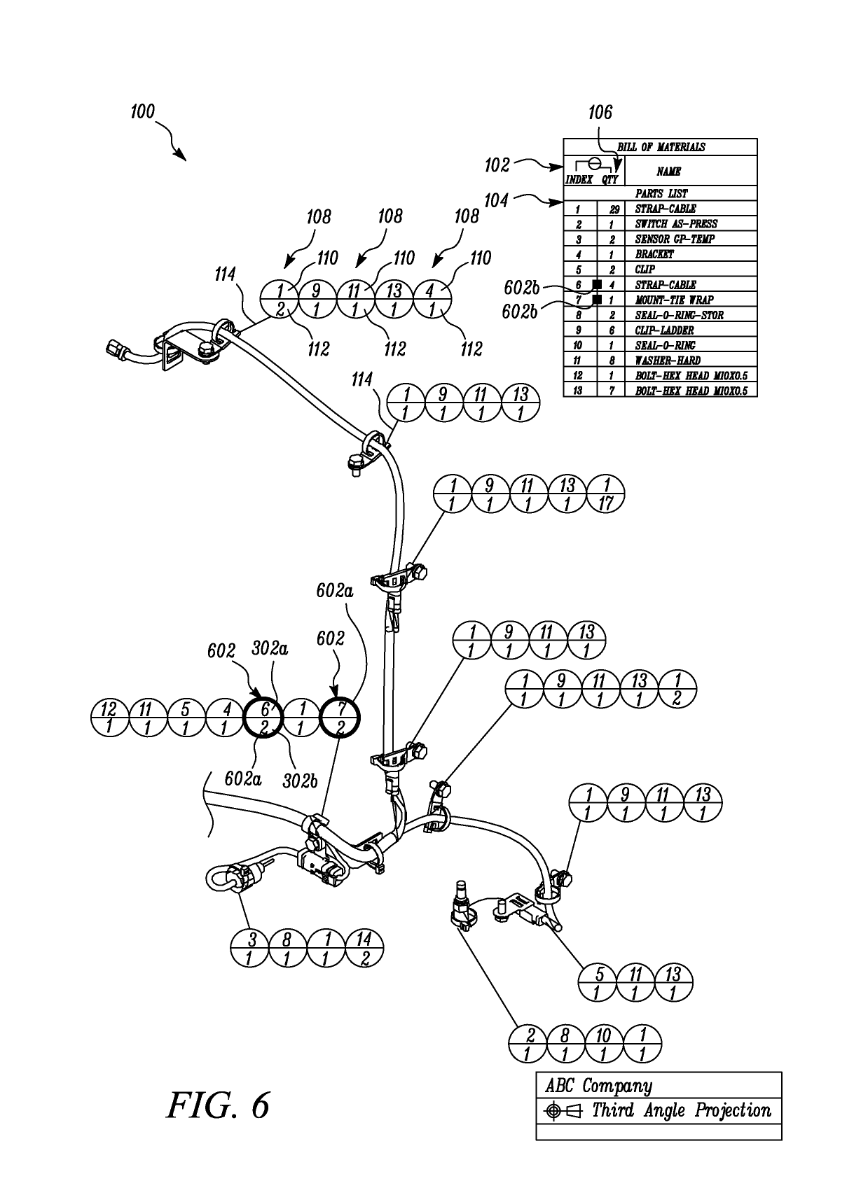

As shown in FIG. 6, the third mark is displayed as circles 602a around respective part call-outs 108 in which the class 302a of the item/part i.e., from the part call-out information 302 is present in the bill of materials information 304, but the first quantity value 302b from the part call-out information 302 is not equal to the second quantity value 304b from the bill of materials information 304 for the given class 302a/304a. For example, in the exemplary part drawing of FIG. 1, the part call-out disclosing class 6 is deemed inaccurate as class 6 exists in the bill of materials 102, however, the first quantity value 302b disclosed for class 6 (see FIG. 3) i.e., 2 is not equal to the second quantity value 304b i.e., 4 listed in the bill of materials information 304 for the given class 6 (See FIG. 2). Hence, the part call-out 108 disclosing class 6 in the part drawing 100 is shown highlighted in FIG. 6 with a circle 602a of the third color for e.g., blue color.

Another example may be similarly inferred from part call-outs 108 that disclose class 7. In this example, first quantity value 302b (See FIGS. 1 and 3) for class 7 is 2; however, second quantity value 304b for class 7 obtained from bill of materials information 304b is 1. As the first quantity value 302b and second quantity value 304b for class value 7 are unequal, the method 200 provides the third indication 602 by way of highlighting the part call-out/s for class 7 in the part drawing (shown in FIG. 6). Moreover, as shown in the bill of materials 102 of FIG. 6, the third indication 602 i.e., a third mark 602b of the third color may, additionally or optionally, be provided alongside the respective classes 6 and 7 to further indicate that the first quantity values 302b disclosed for classes 6 and 7 in the part call-out information 302 (see FIG. 3) is not equal to the second quantity value 304b listed in the BOM information 304.

In yet another embodiment as shown in FIG. 2, if the first quantity value 302b disclosed in the part call-out information 302 for a given class is equal to the second quantity value 304b, then the method 200 may, additionally or optionally, proceed from step 208e to step 208f for identifying whether the first quantity value 302b for a given class disclosed in a given part call-out 108 on the part drawing 100 exceeds a standard deviation for the first quantity value 302b measured from all the part call-outs 108 present in the part drawing, each of the part call-outs 108 being associated with the given class.

As known to one skilled in the art, the standard deviation can be found by taking the square root of the average of the squared differences of the first quantity values 302b from their average value. For example, referring from top to bottom of the part drawing 100 from FIG. 1, part call-outs 108 for class 1 have quantity values 2, 1, 1, 17, 1, 1, 2, 1, 1, 1, and 1 for which an average quantity value may be computed as follows:

(2+1+1+17+1+1+2+1+1+1+1)/11=29/11=2.636

Thereafter, the average quantity value may be deducted from each first quantity value 302b so as to calculate the difference of each first quantity value 302b from the average quantity value, and such difference may be squared i.e., multiplied by itself in the manner as follows:

(2−2.636)̂2=(−0.636)̂2=0.40

(1−2.636)̂2=(−1.636)̂2=2.67

(1−2.636)̂2=(−1.636)̂2=2.67

(17−2.636)̂2=(14.364)̂2=206.32

(1−2.636)̂2=(−1.636)̂2=2.67

(1−2.636)̂2=(−1.636)̂2=2.67

(2−2.636)̂2=(−0.636)̂2=0.40

(1−2.636)̂2=(−1.636)̂2=2.67

(1−2.636)̂2=(−1.636)̂2=2.67

(1−2.636)̂2=(−1.636)̂2=2.67

(1−2.636)̂2=(−1.636)̂2=2.67

Subsequently, a variance in these values may be computed by obtaining an average of these squared values:

(0.40+2.67+2.67+206.32+2.67+2.67+0.40+2.67+2.67+2.67+2.67)/11=20.77

Lastly, the standard deviation may be obtained by computing a square root of the variance as follows:

√20.77=4.58

Therefore, if the first quantity value 302b disclosed in any part call-out 108 for class 1 is greater than the standard deviation i.e., 4.58 (computed using the first quantity values 302b from all the part call-outs 108 for the given class i.e., class 1 in the part drawing 100), then the method 200 of FIG. 2 proceeds from step 208f to step 216 for providing a fourth indication 702 on the respective part call-out 108 i.e., by displaying a fourth mark of a fourth color that is visually distinct from each of the first color, the second color, and the third color. The fourth color may be for e.g., yellow.

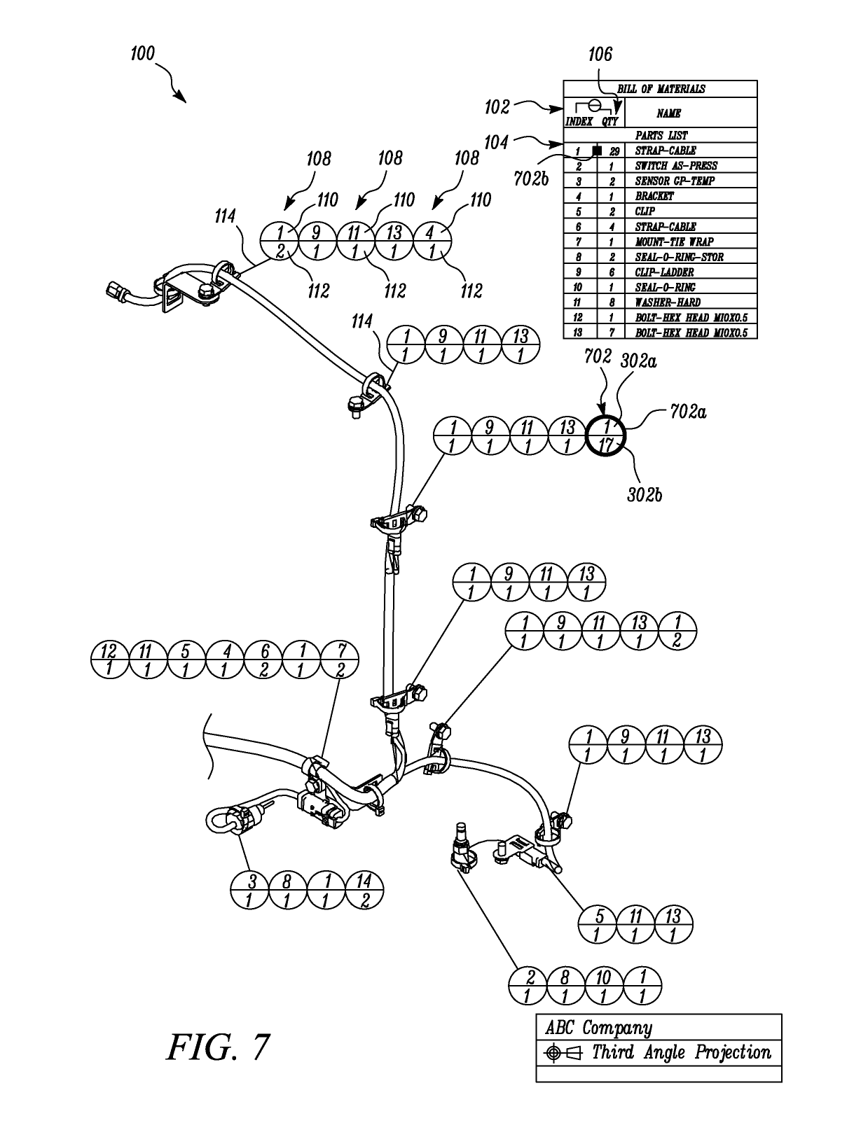

As shown in FIG. 7, the fourth mark is displayed in the form of a circle 702a around respective part call-outs 108 in which the first quantity value 302b exceeds the standard deviation in the first quantity values 302b from all the part call-outs 108 for the given class in the part drawing 100. Therefore, these part call-outs 108 are shown highlighted in FIG. 7 with circles 702a using the fourth color for e.g., yellow color. Moreover, as shown in the bill of materials 102 of FIG. 7, the fourth indication 702 i.e., a fourth mark 702b of the fourth color may, additionally or optionally, be provided alongside the respective class 1 to further indicate that the first quantity value 302b disclosed for class 1 in one or more part call-outs 108 exceeds the standard deviation in the first quantity value 302b from all the part call-outs 108 for class 1 on the part drawing 100.

Although various embodiments of detecting and highlighting accuracies and discrepancies have been independently discussed in conjunction with FIGS. 4-7, one of ordinary skill in the art will acknowledge that such embodiments of detecting accuracies and discrepancies in the part call-outs 108 may be combined to highlight or indicate on a single output file, the accuracies and/or discrepancies in the part drawing 100 of FIG. 1 when processed by the computer system of FIG. 9.

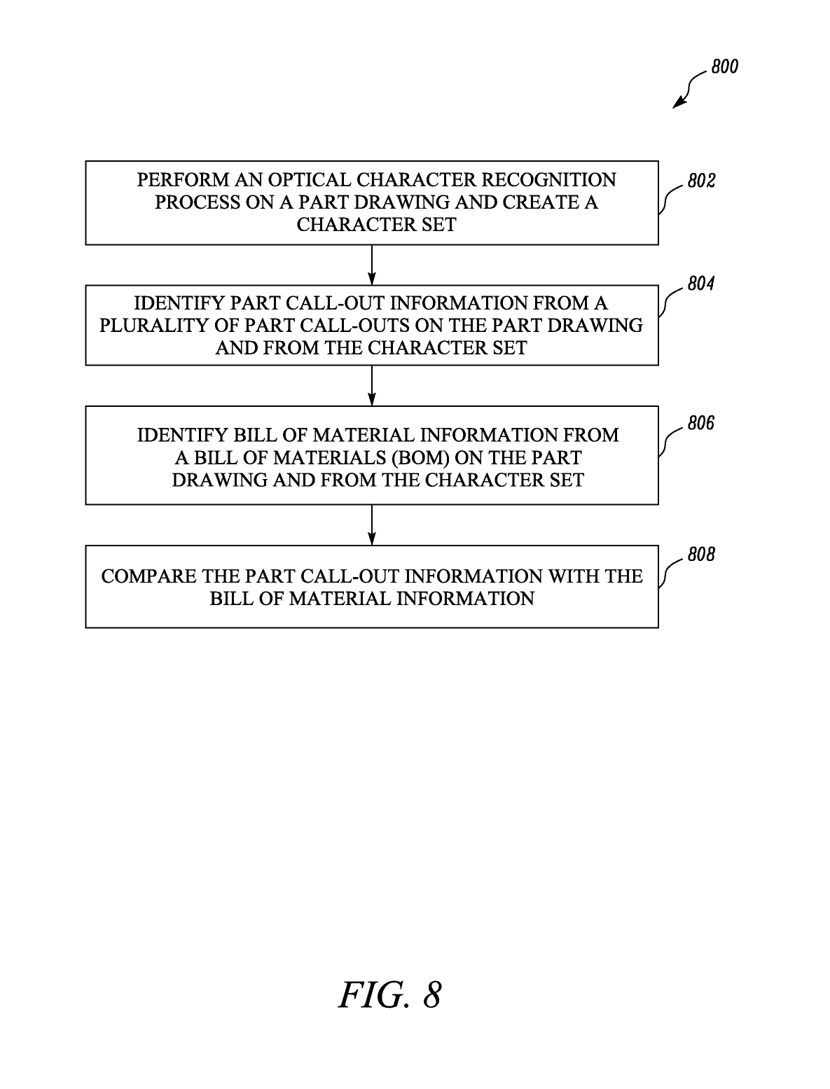

FIG. 8 is a high-level method, pursuant to embodiments of the present disclosure, that can be implemented on the exemplary part drawing of FIG. 1 to detect accuracies and discrepancies between information 302 that is disclosed in one or more part call-outs 108 on the part drawing 100 and information 304 that is listed in an associated bill of materials 102. For sake of brevity in this document, many aspects of the foregoing disclosure have been omitted. However, it should be noted that such aspects are nevertheless similarly applicable to the method 800 of FIG. 8 without limiting the scope of the appended claims.

Referring to FIG. 8, at step 802, the method 800 includes performing the Optical Character Recognition (OCR) process on the part drawing 100 and creating the character set 300. At step 804, the method 800 further includes identifying part call-out information 302 from the plurality of part call-outs 108 on the part drawing 100 and from the character set 300. At step 806, the method 800 further includes identifying bill of material information 304 from the BOM 102 on the part drawing 100 and from the character set 300. At step 808, the method 800 further includes comparing the part call-out information 302 with the bill of material information 304.

FIG. 9 is a block diagram of an exemplary computer system 900 that can be configured to execute instructions consistent with embodiments of the present disclosure. The present disclosure has been described herein in terms of functional block components, screen shots (as shown in FIGS. 4-7), and various processing steps (as shown in FIGS. 2 and 8). It should be appreciated that such functional blocks may be realized by any number of hardware and/or software components configured to perform the specified functions. For example, a general purpose machine such as computer 900, may employ various integrated circuit components, e.g., memory elements, processing elements, logic elements, look-up tables, and/or the like, which may carry out a variety of functions under the control of one or more microprocessors or other control devices. Similarly, the software elements for executing the functions consistent with the present disclosure may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that methods 200/800 may be implemented by employing any number of conventional techniques for data transmission, signaling, data processing, network control, and/or the like. In an embodiment, methods 200/800 may be implemented by the computer 900 using various architecture or platforms such as, but not limited to JavaScript, VBScript, .Net (dot-Net) platform or the like. However, it may be apparent to a person ordinarily skilled in the art that various other software frameworks may be utilized to build the architecture of the computer 900 without departing from the spirit and scope of the disclosure.

These software elements may be loaded onto the general purpose machine or computer 900, a special purpose computer, or any other programmable data processing apparatus, such that the instructions that execute on the computer 900, the special purpose computer, or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce instructions which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present disclosure (i.e., method 200, method 800, part drawing 100, any part(s) or function(s) thereof) may be implemented using hardware, software or a combination thereof, and may be implemented in one or more computer systems or other processing systems. However, the manipulations performed by the present disclosure were often referred to in terms, such as comparing, determining, identifying, or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

In fact, in accordance with an embodiment of the present disclosure, the present disclosure is directed towards one or more computer systems capable of carrying out the functionality described herein. An example of the computer based system includes the computer system 900, which is shown by way of a block diagram in FIG. 9.

Computer system 900 includes at least one processor, such as a processor 902. Processor 902 may be connected to a communication infrastructure 904, for example, a communications bus, a cross-over bar, a network, and the like. Various software embodiments are described in terms of this exemplary computer system 900. Upon perusal of the present description, it will become apparent to a person skilled in the relevant art(s) how to implement the present disclosure using other computer systems and/or architectures.

Computer system 900 includes a display interface 906 that forwards graphics, text, and other data from communication infrastructure 904 (or from a frame buffer which is not shown in FIG. 6) for display on a display unit 908.

Computer system 900 further includes a main memory 910, such as random access memory (RAM), and may also include a secondary memory 912. Secondary memory 912 may further include, for example, a hard disk drive 914 and/or a removable storage drive 916, representing a floppy disk drive, a magnetic tape drive, an optical disk drive, etc. Removable storage drive 916 reads from and/or writes to a removable storage unit 918 in a well known manner. Removable storage unit 918 may represent a floppy disk, magnetic tape or an optical disk, and may be read by and written to by removable storage drive 916. As will be appreciated, removable storage unit 918 includes a computer usable storage medium having stored therein, computer software and/or data.

In order to implement various embodiments of the present disclosure, secondary memory 912 may include other similar devices for allowing computer programs or other instructions to be loaded into computer system 900. Such devices may include, for example, a removable storage unit 920, and an interface 922. Examples of such may include a program cartridge and cartridge interface (such as that found in video game devices), a removable memory chip (such as an erasable programmable read only memory (EPROM), or programmable read only memory (PROM)) and associated socket, and other removable storage units 920 and interfaces 922, which allow software and data to be transferred from removable storage unit 920 to computer system 900.

Computer system 900 may further include a communication interface 924. Communication interface 924 allows software and data to be transferred between computer system 900 and external devices. Examples of communication interface 924 include, but may not be limited to a modem, a network interface (such as an Ethernet card), a communications port, a Personal Computer Memory Card International Association (PCMCIA) slot and card, and the like. Software and data transferred via communication interface 924 may be in the form of a plurality of signals, hereinafter referred to as signals 926, which may be electronic, electromagnetic, optical or other signals capable of being received by communication interface 924. Signals 926 may be provided to communication interface 924 via a communication path (e.g., channel) 928. Communication path 928 carries signals 926 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 916, a hard disk installed in hard disk drive 914, signals 926, and the like. These computer program products provide software to computer system 900. The present disclosure is also directed to use of such computer program products for implementing the methods 200/800 disclosed herein.

Computer programs (also referred to as computer control logic) may be stored in main memory 910 and/or secondary memory 912. Computer programs may also be received via the communication interface 904. Such computer programs, when executed, enable computer system 900 to perform the functions consistent with the present disclosure. In particular, the computer programs, when executed, enable processor 902 to perform the features of the present disclosure. Accordingly, such computer programs represent controllers of the computer system 900.

In accordance with an embodiment of the present disclosure, where the disclosure is implemented using a software, the software may be stored in a computer program product and loaded into computer system 900 using removable storage drive 916, hard disk drive 914 or communication interface 924. The control logic (software), when executed by the processor 902, causes the processor 902 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for implementation and use in detecting and highlighting accuracies and discrepancies in a part drawing with respect to its associated bill of materials.

It is hereby envisioned that with use of embodiments disclosed herein, part drawings may be easily checked for accuracies and/or discrepancies with respect to their associated bill of materials. Use of embodiments disclosed herein may help save time and effort previously incurred in detecting accuracies and discrepancies in part drawings.

When embodiments of the present disclosure are implemented in large, detailed, and/or bulky part drawings, various types of discrepancies can be easily detected and indicated by way of highlights i.e., first, second, third, and fourth indications 402, 502, 602, and 702. Each of these highlights may be indicative that a given part call-out 108 is correct, possibly/partially correct, or incorrect with respect to information 304 that is listed in the bill of materials 102. Moreover, as each part call-out 108 in the part drawing 100 can be individually highlighted with a distinct color depending on a type of accuracy or discrepancy present, use of the methods 200/800 disclosed herein can help design personnel to quickly remedy the discrepancies and produce accurate part drawings on the basis of a type and nature of the discrepancies.

Furthermore, embodiments of the present disclosure can be implemented in conjunction with or across various types of designing and/or modeling platforms. Some examples of designing and/or modeling platforms may include, but is not limited to, AutoCAD®, ProIENGINEER®, Catia®, UNIGRAPHICS®, Creo™ and the like. Therefore, embodiments of the present disclosure may be regarded as being versatile in that they can be implemented across various designing and/or modeling platforms without deviating from the spirit of the present disclosure.

Conventionally produced part drawings have been known to typically incur unnecessary costs and burden to various manufacturing and assembly lines that rely on the accuracy of part drawings. Use of embodiments disclosed herein can help such manufacturing and assembly lines to use accurately produced part drawings and hence, mitigate the unnecessary costs and burden previously incurred with use of the conventionally produced part drawings.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method comprising:
performing an Optical Character Recognition process on a part drawing and creating a character set;
identifying part call-out information from a plurality of part call-outs on the part drawing and from the character set;
identifying bill of material information from a bill of materials (BOM) on the part drawing and from the character set; and
comparing the part call-out information with the bill of material information.

2. The method of claim 1, wherein the step of comparing comprises:
determining a class of an item on the part drawing from the part call-out information; and
identifying if the class of the item from the part call-out information is present in the bill of materials information.

3. The method of claim 2, wherein the step of comparing further comprises:
determining a first quantity value for the class from the part call-out information;
determining a second quantity value for the class from the bill of material information; and
identifying whether the first quantity value and second quantity value for the class are equal.

4. The method of claim 3 further comprising:
providing a first indication if the class from the part call-out information is present in the bill of materials information and if the first quantity value and second quantity value for the class are equal;
providing a second indication if the class from the part call-out information is not present in the bill of materials information; and
providing a third indication if the first quantity value and second quantity value for the class are not equal.

5. The method of claim 4, wherein:
providing the first indication includes displaying a first mark of a first color;
providing the second indication includes displaying a second mark of a second color different from the first color; and
providing the third indication includes displaying a third mark of a third color different from the first color and the second color.

6. The method of claim 5, wherein displaying the first mark includes at least one of:
displaying a circle around a part call-out; and
displaying the first mark of the first color proximate the bill of materials.

7. The method of claim 5, wherein the second mark is displayed as a circle around a part call-out.

8. The method of claim 4, wherein providing the third indication includes:
displaying a circle around a part call-out; and
displaying the third mark of the third color proximate the bill of materials.

9. The method of claim 3 wherein if the first quantity value is equal to the second quantity value, the step of comparing further comprises identifying whether the first quantity value for a given class disclosed in a part call-out exceeds a standard deviation for the first quantity value measured from all the part call-outs present in the part drawing, each of the part call-outs being associated with the given class.

10. The method of claim 9 further comprising providing a fourth indication if the first quantity value for the given class disclosed in the part call-out exceeds the standard deviation measured for the first quantity value from all the part call-outs for the given class in the part drawing.

11. The method of claim 10, wherein providing the fourth indication includes displaying a fourth mark of a fourth color.

12. The method of claim 11 wherein the providing the fourth indication includes displaying a circle around a part call-out.

13. A method comprising:
performing an Optical Character Recognition process on a part drawing and creating a character set;
identifying part call-out information from a plurality of part call-outs on the part drawing and from the character set;
identifying bill of material information from a bill of materials (BOM) on the part drawing and from the character set; and
comparing the part call-out information with the bill of material information, wherein the step of comparing comprises:
determining a class of an item on the part drawing from the part call-out information, and
identifying if the class of the item from the part call-out information is present in the bill of materials information; and
determining a first quantity value for the class from the part call-out information, and a second quantity value for the class from the bill of material information, and
identifying whether the first quantity value and second quantity value for the class are equal; and
identifying whether the first quantity value for a given class disclosed in a part call-out exceeds a standard deviation for the first quantity value measured from all the part call-outs present in the part drawing, each of the part call-outs being associated with the given class.

14. The method of claim 13 further comprising:
providing a first indication if the class from the part call-out information is present in the bill of materials information and if the first quantity value and second quantity value for the class are equal;
providing a second indication if the class from the part call-out information is not present in the bill of materials information; and
providing a third indication if the first quantity value and second quantity value for the class are not equal.

15. The method of claim 14, wherein:
providing the first indication includes displaying a first mark of a first color;
providing the second indication includes displaying a second mark of a second color different from the first color; and
providing the third indication includes displaying a third mark of a third color different from the first color and the second color.

16. The method of claim 15, wherein displaying the first mark includes at least one of:
displaying a circle around a part call-out; and
displaying the first mark of the first color proximate the bill of materials.

17. The method of claim 15, wherein the second mark is displayed proximate the bill of materials.

18. The method of claim 14, wherein providing the third indication includes:
displaying a circle around a part call-out; and
displaying the third mark of the third color proximate the bill of materials.

19. The method of claim 13 further comprising providing a fourth indication if the first quantity value for the given class disclosed in the part call-out exceeds the standard deviation measured for the first quantity value from all the part call-outs for the given class in the part drawing.

20. The method of claim 19, wherein providing the fourth indication includes displaying a fourth mark of a fourth color as a circle around a part call-out.
